(19) United States
(12) Patent Application Publication
(10) Pub. No.: US 2025/0272789 A1
(43) Pub. Date: Aug. 28, 2025

(54) METHOD AND DEVICE FOR GENERATING NATURAL LANGUAGE -BASED TRAINING DATA USING VIDEO AND SCRIPT FILES, AND PERFORMING IMAGE GENERATION AND INFERENCE USING THE TRAINING DATA

(71) Applicant: CJ OliveNetworks Co., Ltd., Seoul (KR)

(72) Inventors: Chan Hyuk Choi, Seoul (KR); Sol Gil Oh, Seoul (KR); Ye Eun Chun, Seoul (KR); Se Un Park, Seoul (KR); Byung-Hak Kim, Seoul (KR)

(21) Appl. No.: 18/784,742

(22) Filed: Jul. 25, 2024

(30) Foreign Application Priority Data
Feb. 27, 2024 (KR) 10-2024-0028310

(51) Int. Cl. G06T 5/20

(52) U.S. Cl. CPC G06T 5/20

(57) ABSTRACT

The present invention relates to a method and device for generating natural language-based training data by pairing video and script files, and performing image search and inference using the generated data including images based on input text prompts.

### TECHNICAL FIELD

The present invention relates to a method and device for generating natural language-based training data by pairing video and script files, and performing image search and inference using the generated data including images based on input text prompts.

### BACKGROUND OF THE INVENTION

In general, to improve the performance of artificial intelligence for image generation, the training data can be built in the process of training a model. For example, OpenAI's DALL-E 3 may map natural language descriptions to training images in order to successfully make image generation from ChatGPT's prompt and more accurately, to improve the alignment between the prompt and the corresponding results from the image generation model. Also, the training model may proceed with training in a way of using the correct answer to the training data to reduce errors.

Meanwhile, a method of configuring data in a conventional training model may mainly include tagging search information and query information through web scraping with text data. However, there is a problem that such search information and text data are not sufficient to explain the image, resulting in a low alignment with the image.

In addition, generally, video media products based on scripts such as dramas or movies have detailed contents written in the script for each scene. However, there is a problem that due to various variables in the filming process, certain parts of the script (e.g., scene transitions, out-of-sync dialogues and scenes, monologue or narration scenes, logo or text noise) are difficult to accurately match to the video.

The present invention is proposed in consideration of the above problems, and relates to performing natural language-based training using video and script files, and generating and inferring images using the data acquired in this way.

### Tasks to be Solved by the Invention

The technical tasks that the present invention aims to solve is to provide a method and device for generating natural language-based content images, where the above method includes for creating a dataset training model, selecting representative images from the dataset, combining the selected images and script files, and converting the combined images and script files into a form for training.

The technical tasks of the present invention are not limited to those mentioned above, and other technical tasks not mentioned will be clearly understood by those skilled in the art from the description below.

### SUMMARY OF THE INVENTION

In a device according to an embodiment of the present invention for achieving the above technical tasks, a method of generating natural language-based training data using an image and a script file and performing image generation and inference using the training data may comprise the steps of receiving the input of a video and a script file, capturing the video file to generate a scene image, outputting a first image by applying an image quality filter to the scene image, applying an OCR quality filter to the first image to output a second image, processing the text of the script file into corpus data, and pairing the second image with the corpus data to generate a dataset.

The method according to an embodiment of the present invention may further include the step of removing black-and-white images or images having a resolution value lower than a preset resolution value from among the images to which the image quality filter has been applied and outputting the remaining images as the first image.

The method according to an embodiment of the present invention may further include the step of applying a text detection filter to the first image to which the OCR quality filter has been applied and confirming an image containing a text among the first images.

The method according to an embodiment of the present invention may further include removing an image containing the text from the first image to which the OCR quality filter is applied and outputting the image as the second image.

The method according to an embodiment of the present invention may further include masking the area where the text has been detected when the size or text size of the area is less than a reference value.

The method according to an embodiment of the present invention may further include replacing the image containing the text with the masked image and applying the OCR quality filter to the first image including the replaced image.

The method according to an embodiment of the present invention may further include encoding text in the script file and classifying the encoded text according to type.

The method according to an embodiment of the present invention may further include tagging a corresponding type of category for the classified text and storing it in the dataset.

The method according to an embodiment of the present invention may further comprise the steps of extracting the front part of a sentence of a specified size for the encoded text, performing a Korean morpheme preprocessing method on the extracted part, and confirming a text part related to the name of the character and classifying the confirmed text part into the name of the character.

The method according to an embodiment of the present invention may further comprise the steps of confirming a voice file related to the video file, determining whether the file name of the video file includes an episode number, and confirming that narration data for the scene image exists which has been set as a target according to the determination result.

The method according to an embodiment of the present invention may further include the step of, if the file name of the video file includes an episode number, setting a scene image corresponding to the episode number among the video files as the target, and if the file name of the video file does not include an episode number, setting all scene images of the video file as the target.

The method according to an embodiment of the present invention may further include the steps of performing voice recognition on the voice file to confirm dialogue data, and performing string matching to calculate the alignment between the corpus data of the scene image set as the target and the dialogue data.

The method according to an embodiment of the present invention may further include the steps of confirming a scene image for which the calculated alignment exceeds a specified value as a result of performing the string matching, and confirming the confirmed scene image as the second image.

The method according to an embodiment of the present invention may further include the steps of calculating context similarity between the narration data and the dialogue data, and if the context similarity exceeds a specified value, pairing the narration data and the second image to generate the dataset, and if the context similarity is less than the specified value, pairing the dialogue data and the second image to generate the dataset.

A device for generating natural language-based training data using video and script files and performing image generation and inference using the training data according to an embodiment of the present invention may comprise a processor and a memory for storing an image generation program configured to, when executed by the processor, receive the input of the video and script files, capture the video file to generate a scene image, output a first image by applying an image quality filter to the scene image, and apply a OCR quality filter to the first image to output a second image, process the text of the script file into corpus data, and pair the second image and the corpus data to generate a dataset.

### Effects of the Invention

According to the present invention as described above, for a training for image search and inference, a representative image is selected from a video file, a script file is processed in a normalized form, and key narration data is extracted from the script file to pair it with the selected image, and a description for the image is generated to combine it with the image and normalize as training data. Accordingly, there is an effect that the image can be effectively trained using the normalized data, thereby enabling image generation, search, and inference.

The effects of the present invention are not limited to the effect mentioned above, and other effects not mentioned will be clearly understood by those skilled in the art from the description below.

### BRIEF DESCRIPTION OF THE DRAWINGS

FIG. 1 is a block diagram showing the configuration of a device according to an embodiment of the present invention.

FIG. 2 is a flowchart showing the steps and operations for generating natural language-based training data using video and script files, according to an embodiment of the present invention.

FIG. 3 is a flowchart showing the steps and operations for processing corpus data using a script file, according to an embodiment of the present invention.

FIG. 4 is a diagram illustrating a screen when a normalized script file is output, according to an embodiment of the present invention.

FIG. 5 is a flowchart illustrating the steps and operations of generating a scene script paired dataset (SSPD) by pairing dialogue data from a voice file with an image filtered from a video file, according to an embodiment of the present invention.

FIG. 6 is a flowchart showing the steps and operations of generating the SSPD by comparing the video file on which voice recognition has been performed with the narration data of the script file, according to an embodiment of the present invention.

FIG. 7 is a flowchart showing the steps and operations of performing image training using the SSPD, according to an embodiment of the present invention.

FIG. 8 is a flowchart showing the steps and operations of performing image generation and search using the SSPD, according to an embodiment of the present invention.

FIG. 9 is a diagram illustrating an example of an image generated using an image generation program in a device according to an embodiment of the present invention.

FIG. 10 is a diagram illustrating an example of an image searched for similarity search using an image generation program in a device according to an embodiment of the present invention.

FIG. 11 is a diagram illustrating an example of images trained and generated using an image generation program in a device according to an embodiment of the present invention.

### DETAILED DESCRIPTION OF THE INVENTION

Hereinafter, preferred embodiments of the present invention will be described in detail with reference to the attached drawings. The advantages and features of the present invention and methods of achieving them will become clear by referring to the embodiments described in detail below along with the attached drawings. However, the present invention is not limited to the embodiments disclosed below and may be implemented in various different forms. The present embodiments are merely intended to ensure that the disclosure of the present invention is complete and to provide fully inform those skilled in the art to which the present invention pertains of the scope of the invention, and the present invention is only defined by the scope of the claims. Like reference numerals refer to like elements throughout the specification.

Unless otherwise defined, all terms (including technical and scientific terms) used in the present specification may be used with meanings that can be commonly understood by those skilled in the art to which the present invention pertains. Additionally, terms defined in commonly used dictionaries are not interpreted ideally or excessively unless clearly specifically defined. The terms used in the present specification are for describing embodiments and are not intended to limit the invention. In the present specification, singular forms also include plural forms, unless specifically stated otherwise the phrases.

As used herein, terms “comprise” and/or “comprising” do not exclude that mentioned component, step, operation and/or element include the presence or addition of other components, steps, operations and/or elements.

Additionally, the word “operation” used in this specification refers to the phenomenon of performing operations as the device is driven internally, and sometimes the word “operation” and the word “step” can be used interchangeably when explaining a series of processes in which the method according to the present invention is performed.

In the present invention, a video file may refer to a file including video or continuous scene images or frames as in drama or movie. The video file may include at least one video file classified into episode (EP) unit.

In the present invention, a script or a script file may refer to a file containing a plurality of dialogs, and optionally narrations, for one unit of video.

In the present invention, a dialogue may be the basic unit of dialogue uttered by a specific person in a video. The dialogue may be classified into sentences for each scene image or into the unit of each sentence.

In the present invention, narration data is text data representing a description of a specific scene image, and it may be captioned on the corresponding scene image and displayed as a subtitle. For example, the narration data may include information describing the actions or instructions of a specific person in a specific scene image.

In the present invention, a subtitle is an area where dialogue or narration data is displayed in a scene image, and it may be displayed as text or an image.

With reference to the above matters, the description of the present invention will be continued below based on the drawings.

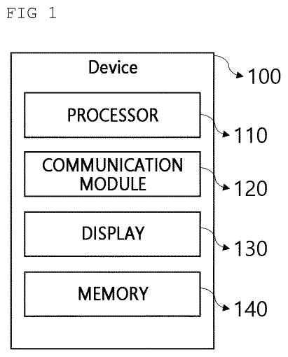

FIG. 1 is a block diagram showing the configuration of a device according to an embodiment of the present invention.

Referring to FIG. 1, a device 100 may comprise a processor 110, a communication module 120, a display 130 and a memory 140.

According to one embodiment of the present invention, the processor 110 may perform the overall operations of the device 100. For example, the processor 110 may generate a scene script paired dataset (SSPD) based on video and script files and perform image generation and image inference operations corresponding to the prompt based on the generated SSPD.

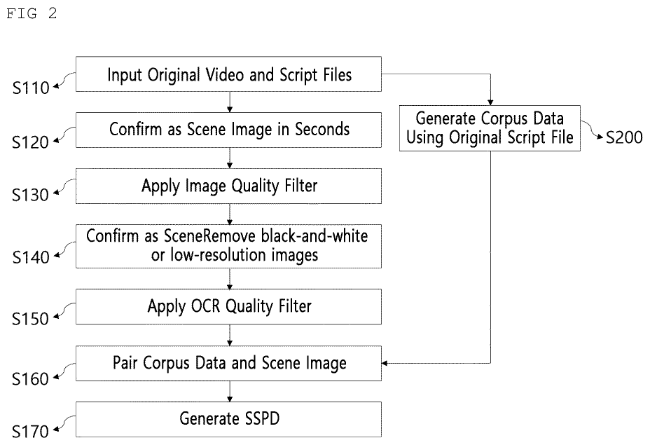

The operations performed by the processor 110 will be explained in more detail through in FIG. 2 and other figures, which will be described later, the operations are briefly listed below.

The processor 110 may use an image generation program to remove black-and-white images or images with a resolution lower than a preset value from among the images to which the image quality filter has been applied and output the remaining images as the first image.

Also, according to an embodiment of the present invention, the processor 110 may use an image generation program to apply a text detection filter to the first image to which the OCR quality filter has been applied, confirm an image including the text from among the first image to which the OCR quality filter has been applied, remove the image including the text from among the first image to which the OCR quality filter has been applied and output the remaining images as the second image.

According to one embodiment of the present invention, if the size of the area where the text has been detected in the image including the text or the size of the text is less than a reference value, the processor 110 may use an image generation program to mask the area where the text has been detected. Thereafter, the processor 110 may use the image generation program to replace the image including the text with the masked image and apply the OCR quality filter to the first image including the replaced image.

According to one embodiment of the present invention, the processor 110 may use the image generation program to encode the text of the script file and classify the encoded text by type, and tag the classified text with a category of the corresponding type and store it in the dataset.

According to one embodiment of the present invention, the processor 110 may use the image generation program to extract the front part of a sentence of a specified size for the encoded text, perform a Hangul morpheme preprocessing method on the extracted part, confirm the text part related to the name of the character in the extracted part and classify the confirmed text part as the name of the character.

According to one embodiment of the present invention, the processor 110 may use an image generation program to confirm a voice file related to the video file and determines whether the file name of the video file includes an episode number, and confirm a narration data for the scene image set as the target based on the determination result.

According to one embodiment of the present invention, the processor 110 may use an image generation program to set the scene image corresponding to the episode number in the video file as the target, if the file name of the video file (or other identifier that may classify the video file) includes the episode number. Meanwhile, if the file name of the video file does not include an episode number, the processor 110 set all scene images in the video file as the target.

According to one embodiment of the present invention, the processor 110 may use an image generation program to confirm dialogue data by performing voice recognition on the voice file and perform a string matching for calculating the alignment between the corpus data of the scene image set as the target and the dialogue data. Thereafter, if a scene image whose calculated alignment exceeds a specified value is confirmed as a result of performing the string matching, the processor 110 may confirm the confirmed scene image as the second image.

According to one embodiment of the present invention, the processor 110 may use an image generation program to calculate the context similarity between the narration data and the dialogue data. Thereafter, if the context similarity exceeds a specified value, the processor 110 may pair the narration data and the second image and generate it as the dataset, and if the context similarity is less than the specified value, the processor 110 may pair the dialogue data and the second image and generate it as the above dataset.

Meanwhile, according to one embodiment of the present invention, when a user's confirmation request for the SSPD generated through an image generation program is inputted, the communication module 120 may transmit the SSPD to a device of an expert user (e.g., photographer, writer, director). Also, the communication module 120 may receive a response to the confirmation request transmitted by the device of the expert user in response to the transmission.

Also, according to an embodiment of the present invention, the display 130 may collectively refer to a configuration that outputs the SSPO of a format which users may confirm and the like on the screen.

Also, according to one embodiment of the present invention, the memory 140 a memory may store an image generation program configured to, when executed by the processor, confirm the input of a video file and a script file, capture the video file every second and confirm it as scene image in seconds, output a first image by applying an image quality filter to the scene image, output a second image by applying an optical character recognition (OCR) quality filter to the first image, process the text of the script file as corpus data, and pair the second image and the corpus data and generate it as a dataset.

For reference, it is understood that among the components of the device 100, the processor 110 and memory 140 will be considered essential components necessary for executing the method according to the present invention and that the communication module 120 or display 130 is a component that may be omitted depending on the needs of the person designing the device 100 or the needs of the consumer.

FIG. 2 is a flowchart showing the operation of generating natural language-based training data using video and script files, according to an embodiment of the present invention.

Referring to FIG. 2, in operation S110, the device 100 may receive and confirm the input of an original video file and an original script file for generating an image of training data. According to one embodiment, the video file may be downloaded from a web-based platform (e.g., YouTube) using a video download module (e.g., Python package youtube-dl, pytube, etc.), and the device 100 may receive a video downloaded in this way. Also, the original script file may also be downloaded from the outside to the device 100 or transmitted to the device 100 in other ways.

In operation S120, the device 100 may capture the inputted original video file every second to acquire a scene image in seconds and confirm it. For example, the device 100 may capture and acquire a scene image every N second (e.g., N=1) using a video file capture module (e.g., Python package ffmpeg).

In operation S130, the device 100 may apply an artificial intelligence-based image quality filter (e.g., aesthetic score filter) to the confirmed scene image.

In operation S140, the device 100 may remove black-and-white image or low-resolution image from the scene image to which the image quality filter has been applied. For example, the device 100 may apply the image quality filter or the text detection filter to purify a monochromatic image, a low-resolution image, or an image including a lot of text in the scene image captured and confirmed in the operation S120 so that only high-quality images are filtered out. This is to select only high-quality images and use them as training data.

Meanwhile, when applying a text detection filter in the operation S140, the device 100 may be implemented to use a screen with a small proportion of text (subtitle) among scene images as a high-quality image, which corresponds to operation S150 in the drawing. The device 100 may apply an OCR quality filter (e.g., OCR score filter) to any scene image in which if the size or number of characters that the detected text occupies on the screen is less than the reference value, the device 100 may generate a black and white image (e.g., Mask Image) based on the detected text area, use the original image and the masked black and white image as the input, delete the part with text and apply an image restoration model (e.g. Stable Diffusion Inpainting Model) that estimates the image of that part thereby acquiring a high-quality image without text. Meanwhile, although the S140 operation and the S150 operation are shown as different operations in the drawing, the operations S140 and S150 may be designed to be performed as one operation as needed.

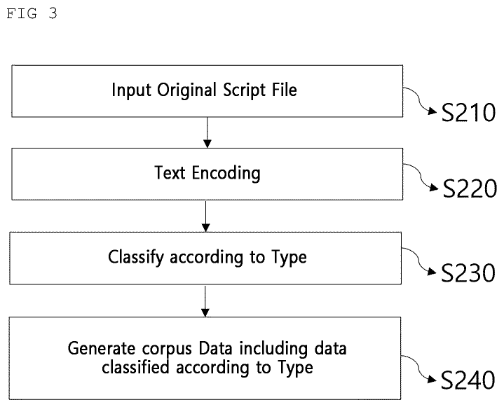

Meanwhile, in operation S200, the device 100 may confirm the input of an original script file for inserting a caption for an image of training data and process the text of the inputted original script file as corpus data. The process of processing as the corpus data will be described in detail later in the explanation of FIG. 3.

Meanwhile, in operation S160, the device 100 may pair corpus data and scene images according to the performance of operations S121 and S200 described above.

In operation S170, the device 100 may generate the paired data as a scene script paired dataset (SSPD). Also, the device 100 may transmit a confirmation request for the paired data to the device of a pre-designated expert user (e.g., photographer, writer, director) and receive a response to the confirmation request from the expert user's device. Accordingly, the device 100 may select only data for which the response has been received as the SSPD data.

FIG. 3 is a flowchart showing the processing operation corpus data using a script file, according to an embodiment of the present invention.

Referring to FIG. 3, the operation S200 of FIG. 2 may include an operation of confirming the input of the original script file (S210), an operation of encoding the text (S220), an operation of classifying the encoded text according to type (S230) and an operation (S240) of generating corpus data including data classified according to text type.

In operation S210, the device 100 may confirm the input of the original script file.

In operation S220, the device 100 may encode the text of the original script file. For example, the device 100 may convert the original script file into a designated extension (e.g., .txt), and perform designated language encoding (e.g., Korean UTF-8 encoding) on the converted file and store it.

In operation S230, the device 100 may classify the encoded text according to type. For example, the type may be classified into character unit, scene unit and narration/dialogue unit.

First, in classifying the text of character unit, the device 100 may extract the front part of a sentence of a specified size (e.g., 8 Korean characters) for text encoded in a specific episode unit and perform Korean morpheme preprocessing method (e.g., Kiwi) on the extracted part, thereby classifying the text in the character unit. Extracting the front part of the sentence to only the specified size is because there is a high probability that a character's name is included at the front of the sentence in the individual sentences that generally make up the script, and in the present invention, it is preferable to extract and process only the first 8 letters of the sentence, thereby efficiently extracting a list of characters. Through this preprocessing method, the device 100 may remove non-name elements (e.g., verbs, adjectives) from the extracted part and output the list of characters in which the characters are listed in the order of the characters that appear most frequently in the entire text as a resulting value.

Next, when classifying text in a scene unit, the device 100 may recognize the scene delimiter (e.g., S #1, S/1, #1., 1.) included in the encoded text using a regular expression and group the encoded text into sentences of a scene unit. Thereafter, the device 100 may apply a binary classification model to the sentences grouped in a scene unit, thereby classifying the sentences as narration or dialogue.

Also, when classifying a text in narration/dialogue unit, if the encoded text includes the sentence “Hong Gil-dong: “Here . . . (eyes looking around) where is it?”, the device 100 may store the sentence classified in the text by tagging it with a delimiter. For example, the device 100 may classify “Here . . . (eyes wandering around) where is it?” or “Here . . . ” and “where is it?” in the sentence as a dialogue and tag the sentence with ‘script-dialog’, classify “(eyes looking around)” as a sentence in the script that represents the character's action and tag it with ‘script-action’ and then store it. In addition, the device 100 may classify the sentence related to the narration of the scene in the encoded text as narration, tag the sentence with ‘narration’ and then store it.

In operation S240, the device 100 may generate corpus data including data classified according to text type and store the generated corpus data in a designated format (e.g., json).

According to an embodiment of the present invention, the device 100 may generate corpus data in which each sentence from a script file has been classified and stored. Accordingly, as the classified sentence includes information on dialogue, narration, action, or instruction, the device 100 can minimize noise (e.g., dialogue data) thereby performing an image generation using the sentence.

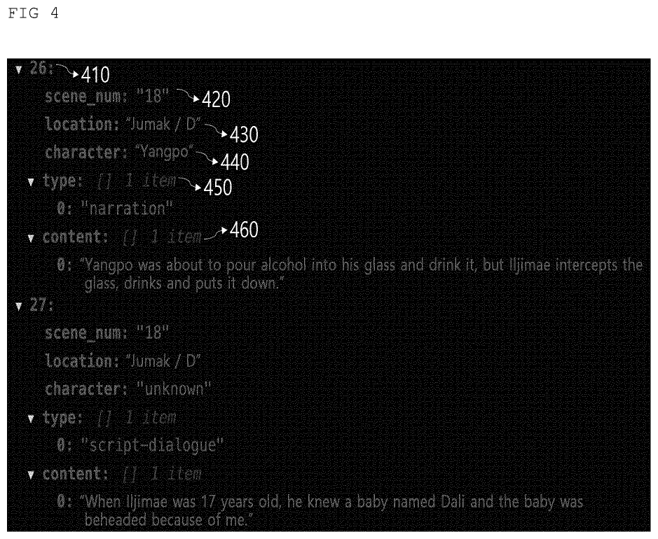

FIG. 4 is a diagram illustrating a screen when a normalized script file is outputted according to an embodiment of the present invention.

According to one embodiment of the present invention, under the confirmation of the input of the original script file, the device 100 may encode the inputted script file and process it in a normalized form and output the screen 400 of the script file on the display 130.

Referring to FIG. 4, the screen 400 of the normalized script file may display by classifying the text in the script file into the category of a dialogue delimiter 410 for delimiting each dialogue, a scene number (scene num) 420, the location 430 of the scene, character 440 of the scene, type 450 of dialogue and content 460 of the dialogue. For example, in the case of a dialogue with a script delimiter 410 of ‘26’ in the screen 400, the scene number 420 is 18, the location 430 is ‘Jumak/D’ representing a jumak during the day (D: day), the character 440 is ‘Yangpo’, and the type 450 of dialogue is “narration”, wherein as the content 460 of the dialogue, ‘I'm about to pour alcohol into a Yangpo's glass and drink it, but Iljimae intercepts the glass, drinks and puts it down’ may be included.

According to one embodiment of the present invention, the device 100 may classify the text of the encoded script file according to the categories, generate and store SSPD including information on each category as metadata.

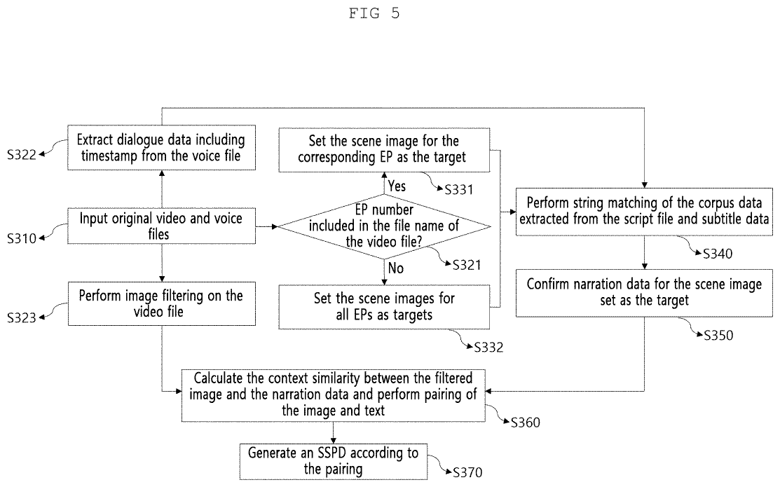

FIG. 5 is a flowchart illustrating the operation of generating an SSPD by pairing dialogue data with an image filtered from a video file, according to an embodiment of the present invention. For reference, in order to introduce more various embodiments, a case where dialogue data is extracted from a video voice file is assumed and explained in FIG. 5.

Referring to FIG. 5, the device 100 may generate an SSPD using a voice file input along with an original video file.

If the device 100 confirms the input of the original video and voice files in operation S310, it determines whether the EP number is included in the file name of the video file (or, in addition, an identifier that may confirm the video file) in operation S321. In operation S322, dialogue data including a timestamp may be extracted from the voice file, and an image filtering may be performed on the video file in operation S323.

As a result of performing the above-described operation S321, if the EP number is included in the file name of the video file, the device 100 may set the scene image for the corresponding EP among the scene images of the video file as the target in operation S331.

As a result of performing the above-described operation S321, if the EP number is not included in the file name of the video file, the device 100 may set the scene image for all EPs of the video file as the target in operation S332.

If the above-described operation S322 is performed, in operation S340, the device 100 performs the above-described operation S331 or operation S332, thereby performing string matching to calculate the alignment between the corpus data of the scene image set as the target and the extracted dialogue data. For example, the device 100 may perform string matching only on dialogue data including long text (e.g., 10 characters or more) among dialogue data extracted from the voice file in order to shorten the processing time in the subsequent pairing operation. Also, the device 100 may perform the string matching using an alignment calculation module (e.g., fuzzywuzzy in python) and then proceed to the next step only when the alignment is calculated to be 70% or more, thereby preventing additional calculation for pairing regarding the dialogue scene with low alignment from being performed.

As the above-described operation S340 is performed, the device 100 may acquire and confirm narration data for the scene image set as the target in operation S350.

Next, in operation S360, the device 100 may calculate the context similarity between the filtered image and the narration data and perform pairing of the text of the filtered image and the narration data. At this time, in order to increase pairing efficiency, the image may be implemented to include images with consistent image quality and hue. For example, the device 100 may confirm images that include the same watermark among the images in the video file or have designated hues as images for which the pairing is to be performed, thereby increasing the efficiency of training and pairing.

According to one embodiment of the present invention, the device 100 may extract features from images and texts to be paired using an artificial intelligence model (e.g., CLIP model). For example, the device 100 may extract and vectorize features using different models (e.g., CLIP vision and text feature embeddings) for each image and text.

According to one embodiment of the present invention, the device 100 may calculate the context similarity between the filtered image and the narration data by using a metric (e.g., cosine similarity metric) that calculates the context similarity according to features extracted for the filtered image and the narration data. Thereafter, the device 100 may pair the image and text with the highest context similarity value among the calculated context similarities. In addition, the device 100 may perform pairing on images and texts that have a context similarity value greater than or equal to a specified value.

Finally, in operation S370, the device 100 may generate an SSPD including the paired image and text.

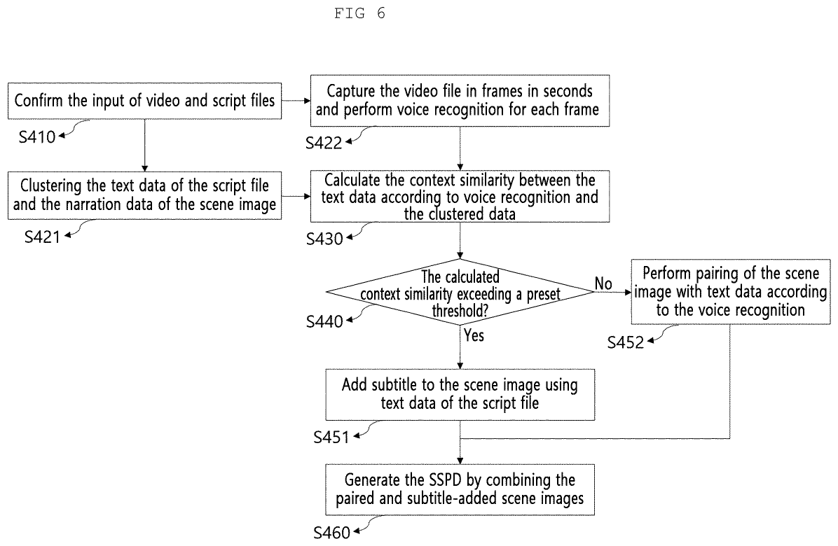

FIG. 6 is a flowchart illustrating the operation of generating an SSPD by comparing narration data of a video file on which voice recognition has been performed and a script file, according to an embodiment of the present invention.

Referring to FIG. 6, in operation $410, the device 100 may confirm the input of a video file and a script file.

When operation S410 has been performed, the device 100 may cluster the text data of the script file and the narration data of the scene image in operation S421, and capture the video file in frames in seconds and performs voice recognition for each frame in operation S422. Thereafter, as a result of performing the voice recognition, the device 100 may confirm the voice of the video file as text data for each frame.

In operation S430, the device 100 may calculate the context similarity between the text data according to voice recognition for the frame and the clustered data using an artificial intelligence model (e.g., CLIP model).

In operation S440, the device 100 may determine whether the calculated context similarity exceeds a preset threshold.

As a result of performing the above-described operation S440, if the calculated context similarity exceeds the threshold, the device 100 may determine that the voices of the script file and the video file are similar each other, and add text data of the script file to the scene image as subtitle in operation S451.

As a result of performing the above-described operation S440, if the calculated context similarity is below the threshold, the device 100 may determine that the voices of the script file and the video file are different each other, and in operation S452, the device 100 may perform pairing with the scene image using text data according to the voice recognition, instead of the script file.

In operation S460, the device 100 may generate the SSPD by combining the paired and subtitle-added scene images.

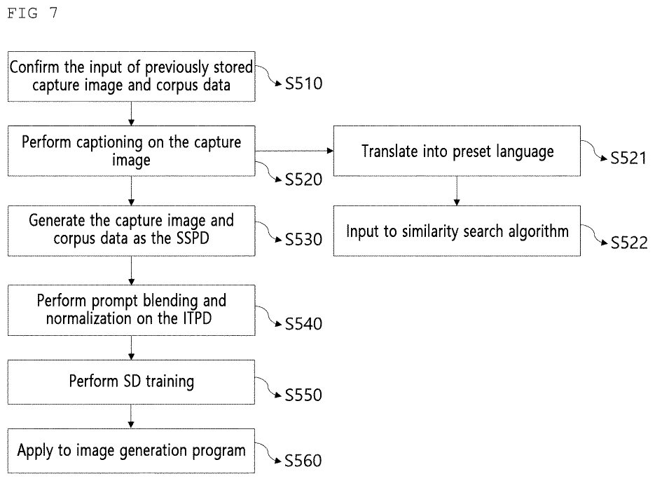

FIG. 7 is a flowchart showing the operation of performing image training using the SSPD, according to an embodiment of the present invention.

Referring to FIG. 7, in operation S510, the device 100 may receive and confirm previously stored capture images and corpus data. For example, the capture image may be a scene image captured every second from a previously inputted video file, and the corpus data may be text data that may be acquired from the script file.

In operation S520, the device 100 may perform captioning for adding a subtitle to the capture image using a caption addition module (e.g., KOSMOS2 or blip).

According to one embodiment of the present invention, the device 100 may infer a subtitle related to the capture image using a sentence generation model (e.g., Vision2Sequence) and add the inferred subtitle to the capture image. Also, the device 100 may cause detailed information about the capture image to be added as a subtitle as a first command (e.g., “Describe this image in detail”) is inputted as a prefix prompt and brief information about the capture image to be added as a subtitle as a second command (e.g., “An image of”) is inputted.

According to one embodiment of the present invention, a prompt which is a phrase or instruction entered by a user may be inputted to the interface of an image generation program. Also, the device 100 may set various prompts for a specific image and cause an image, in which a prompt corresponding to the inputted prompt has been set, to be outputted.

When operation S520 has been performed, the device 100 may translate the captioned subtitle into a set language (e.g., Korean, English) using a translation module (e.g., Gugugo in python) in operation S521, and then generate the capture image and corpus data as the SSPD in operation S530.

According to one embodiment of the present invention, if the subtitle is in English, the device 100 may convert it into Korean, which is a preset language, using a Korean translation model (e.g., Gugugo, Synatra in python). For example, the Korean translation model may perform a parallel inference by connecting sequences available by a graphic processing unit (GPU) of the device 100 in a batch (e.g., 16 or more).

According to an embodiment of the present invention, the device 100 may set a condition for a decoding output stopping (stoppingCriteria) for the Korean translation model (e.g., Gugugo) and cause a decoding output to be stopped according to the set condition. For example, the condition for the decoding output stopping may include the batch size or the maximum length (max_length) (e.g., 300 or less) of the subtitle according to the token for performing captioning.

According to one embodiment of the present invention, the device 100 may replace or modify words in the subtitle inferred based on language characteristics. For example, if the language is Korean, the device 100 may train the Korean translation model to delete ‘seopni’ from the inferred subtitle in the light of its characteristics with respectful words included therein.

When the operation S521 has been performed, the device 100 may input the translated subtitle into a similarity search algorithm (e.g., CLIP) in operation S522.

When operation S530 has been performed, the device 100 may generate an image-text pair dataset (ITPD) by performing prompt blending on the SSPD and perform normalization on the ITPD in operation S540.

According to one embodiment of the present invention, the device 100 may perform prompt blending to blend the inferred subtitles and narration data acquired from the corpus data at a preset ratio (e.g., 99.5:0.5 to 90:10). Among the subtitles inferred by the device 100 and the narration data (edited by humans) acquired from the corpus data, the latter is more likely to describe the image more accurately and thus it is more desirable to be used as data during training. However, in reality, the amount of subtitles inferred by the device 100 is much larger than the simulated data acquired from the corpus data, so it is necessary to blend the two types of data at a preset ratio. Accordingly, image training based on subtitles and script files may be possible in the later model training process.

Meanwhile, by implementing the device (100) to exclude, among the data in the script file, data whose metric (e.g., clip_logit) for determining image text matching quality is below the threshold or when multiple images for duplicated narration data have been mapped, to blend only the top n data (e.g., n=10) or less based on the value of the metric, training may be made possible only with high-quality data.

According to one embodiment of the present invention, the device 100 may collectively add specific concept keywords (e.g., actor name, drama type (e.g., period drama, historical drama), zeitgeist, etc.) to the data of the script file so that specific concept keywords and capture images are mapped. For example, in dramas, movies and the like where the video background deals with the past with different costumes such as the Korean Three Kingdoms period, Goryeo period, or Joseon period, the device 100 adds ‘period drama’ or ‘historical drama’ as keywords before and after the prompt in dramas and movies. Also, when the device 100 has confirmed the role name or actor name of the actor appearing in the capture image from the script file, the device 100 may collectively replace the narration of characters such as men and women with the confirmed role name.

In operation S550, the device 100 may perform SD training on the normalized ITPD using a stable diffusion (SD) module. Accordingly, the device 100 may confirm the training dataset according to the performance of the SD training.

In operation S560, the device 100 may input the training dataset into an image generation program (e.g., hereafter named as IMGEN: image generator). Thereafter, the device 100 may perform image generation and search using the image generation program.

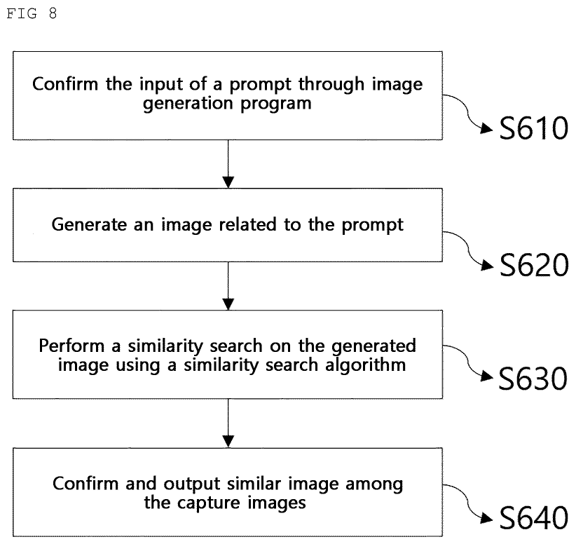

Explanation regarding image generation and search operations according to an embodiment of the present invention will be continued with reference to FIG. 8.

FIG. 8 is a flowchart showing the operation of performing image generation and search using SSPD, according to an embodiment of the present invention.

Referring to FIG. 8, in operation S610, the device 100 may receive and confirm an input of a prompt (e.g., “boy and girl students”) through an image generation program.

In operation S620, the device 100 may generate an image related to the prompt using an image generation program.

According to one embodiment of the present invention, the device 100 may confirm a pre-stored training dataset through the image generation program. Thereafter, the device 100 may use an image generation model (e.g., my-korean-stable-diffusion-v1.5) that performs pre-training by fine-tuning the image and text paired in the training dataset with input data.

According to one embodiment of the present invention, the device 100 may generate an image corresponding to a prompt using the image generation model and the final image in which a pre-specified prompt set (e.g., 8 k, muted color, vivid, realistic) has been applied to the generated image.

In operation S630, the device 100 may perform a similarity search on the generated image using a similarity search algorithm. For example, the device 100 may calculate feature embeddings of the image using a text feature extraction artificial intelligence model (e.g., CLIP vison & text encoder) and generate the generated image as high-dimensional feature vector data.

According to one embodiment of the present invention, the device 100 may generate an index from the metadata of the script file using a similarity search tool (e.g., FAISS) and store to include the generated index. Thereafter, the device 100 may extract characteristics from a pre-stored image and perform a similarity search on the feature vector data.

In operation S640, the device 100 may confirm a similar image which is similar to the prompt among the capture images captured in the video file according to the performance of the similarity search and output the confirmed image.

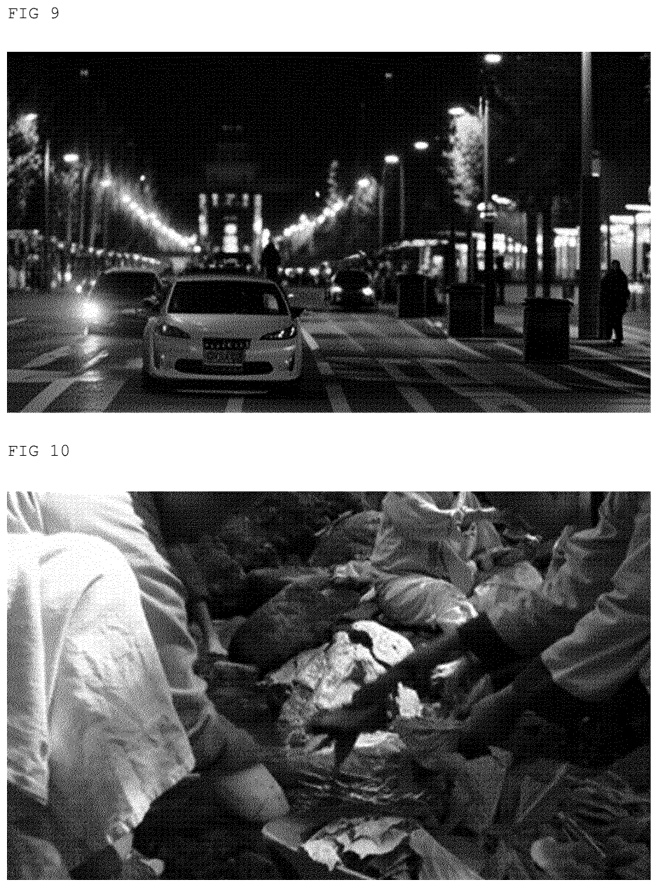

FIG. 9 is a diagram illustrating an example of an image generated using an image generation program in a device according to an embodiment of the present invention.

Referring to FIG. 9, if a prompt (e.g., ‘many cars and people in the city at the middle of the night’) is inputted, the device 100 may generate an image 900 corresponding to the inputted prompt by referring to the previously generated SSPD.

For example, the device 100 may classify the prompt into text in word units and confirm a dataset including the text corresponding to each word among the SSPD as metadata. Thereafter, the device 100 may apply the confirmed dataset and the text of the prompt as input data to the image generation model.

According to one embodiment of the present invention, the device 100 may use the image generation model to generate an image 900 of cars and people in the city as an image taken at night which corresponds to the prompt.

FIG. 10 is a diagram illustrating an example of an image searched for similarity search using an image generation program in a device according to an embodiment of the present invention.

According to one embodiment of the present invention, the device 100 may generate an SSPD using the captured image captured from the video file and the corpus data of the script file through an image generation program, and if a prompt (e.g., ‘period drama, wild vegetable lower village women chop vegetables such as garlic, green onion and perilla leaf and add in a cauldron’) is inputted, the device 100 may generate an image corresponding to the prompt and perform a similarity search on the generated image using the SSPD.

Referring to FIG. 10, the device 100 may search for a similar image 1000 similar to the prompt among the captured images by performing a similarity search. For example, when the captured image is generated as SSPD, the device 100 may search for an image with an added keyword ‘period drama’ as a drama type or images with added keywords such as a ‘wild vegetable lower village’, ‘lower village women’, ‘garlic’, ‘vegetables’ and ‘cauldron’, which are metadata, as similar images (1000).

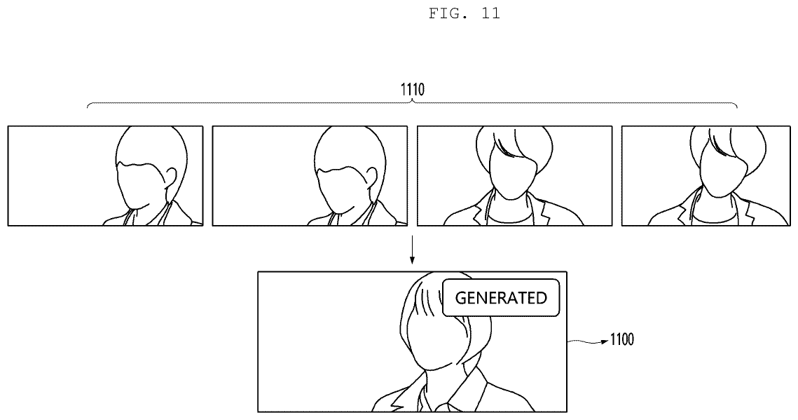

FIG. 11 is a diagram illustrating an example of images learned and generated using an image generation program in a device according to an embodiment of the present invention.

Referring to FIG. 11, the device 100 may confirm that a plurality of images 1110 for the same narration data (e.g., lady, she is at a construction site) are mapped and generated as SSPD through an image generation program.

According to one embodiment of the present invention, the device 100 may determine the image text matching quality for the data of the script file of the image 1110 and perform a prompt blending to blend only data satisfying the specified criteria. Thereafter, the device 100 may generate an ITPD based on the prompt blending and perform normalization on the ITPD.

According to an embodiment of the present invention, the device 100 may perform SD training on the normalized ITPD and input a training dataset according to the SD training to the image generation program. Thereafter, if a prompt (e.g., ‘lady, she is at a construction site’) is inputted through the image generation program, the device 100 may generate an image paired with the training dataset and an image corresponding to the text of the prompt (e.g., ‘lady’, ‘construction site’).

Meanwhile, the image generation and inference method described above may be used for more diverse purposes.

As an example of use, the accuracy of image generation and inference may be increased by generating a corpus from a script file and then classifying each sentence into narration/dialogue, and having the device 100 generate matching images only for sentences classified as narration except sentences classified as dialogue. In general, the corpus acquired from the script file includes more information for image generation in the sentence parts classified as the description (narration) wherein by excluding the sentence corresponding to the dialogue when generating the image, the image may be generated with minimal noise.

As another example of use, the user may allow the device 100 to use an image generator to easily make illustrations that may be inserted into text-based works such as novels, webtoons and fairy tales. As seen above, the present invention may accurately generate various types of images using only a prompt (text) entered by the user, and from the perspective of the user, the most suitable ones as illustrations may be selected from among a plurality of generated candidate images and used in the work. From the perspective of the user, especially author, he/she may repeatedly generate images as they intended, thereby acquiring the effect of reducing costs and the time required to produce the illustration. Further, from the author's perspective, the author may create images for each scene by simply entering the text of the novel, webtoon, or fairy tale that the author has created, and therefore, the effect of omitting procedures such as writing additional text and delivering it to the illustration artist to acquire the desired illustration can be achieved.

As still another example of use, the user may use the device 100 to generate images that may represent a work or idea, and these images may be used for various purposes such as introducing the work or pitching ideas to production companies. For example, if a playwright needs to introduce his or her work in a short period of time, multiple images may be acquired by inputting the text of the work to be introduced (play script, drama script, etc.), and the playwright may effectively develop the entire work and explain important scenes by selecting only the images to introduce key scenes among them. Meanwhile, not only selected images, but also a summary of the text in the work into preset units (e.g. chapter, etc.) are materialized together with images for each unit, thereby accurately and quickly making a material that may briefly introduce a work or idea.

As further still another example of use, if the SSPD has undergone sufficient training and has constructed a database of a considerable size, a device 100 may be implemented that allows the user to search for a desired image from the SSPD database by entering a prompt. For example, when the user has entered “he/she starts pouring a cubed radish kimchi soup into his/her own earthenware bowl and stirring it to eat,” the device 100 may search for an image of a scene in which a cubed radish kimchi soup is poured into an earthenware bowl from the SSPD database and display it to the user. Additionally, in the SSPD database, the concept or trend of SSPD may be determined depending on what types of videos and scripts are used for training. As such, there is an effect that as there exists a certain thought or direction that appears in multiple SSPDs, the user acquires a scene image according to the event or direction of the SSPD every time the user enters a prompt. For example, when the user has entered the prompt “a man who stands at a construction site is crying,” the user may search for Korean drama-style scene image from the SSPD database formed based on Korean drama scenes and scripts.

Meanwhile, the above-described embodiments are only preferred embodiments in achieving the object of the present invention, and some steps may be added or deleted as needed, and one step may be performed by being included in another step.

Although embodiments of the present invention have been described above with reference to the attached drawings, those skilled in the art will be able to understand that the present invention may be implemented in other specific forms without changing its technical idea or essential features. Therefore, it should be understood that the embodiments described above are illustrative and not limited in all respects.

1. A method of, by a device, generating natural language-based training data using video and script files and performing image generation and inference using the training data, comprising the steps of:
receiving the input of a video file and a script file;
capturing the video file to generate a scene image;
outputting a first image by applying an image quality filter to the scene image;
processing the text of the script file into corpus data; and
pairing the first image and the corpus data to generate a dataset.

2. The method according to claim 1, wherein the step of outputting the first image includes removing black-and-white image or image having a resolution value lower than a preset resolution value from among the images to which the image quality filter has been applied and outputting remaining images as the first image.

3. The method according to claim 1 further comprising the steps of, after outputting the first image, applying an OCR quality filter to the first image to output a second image; and applying a text detection filter to the first image to which the OCR quality filter has been applied to confirm an image containing a text in the first image.

4. The method according to claim 3 further comprising the step of removing the image containing the text from the first image to which the OCR quality filter has been applied and outputting the remaining images as second images.

5. The method according to claim 3 further comprising the step of, if the size or text size of the area where the text has been detected in the image is less than a reference value, masking the area where the text has been detected.

6. The method according to claim 5 further comprising the steps of replacing the image containing the text with the masked image; and applying the OCR quality filter to the first image including the replaced image.

7. The method according to claim 1 further comprising the step of encoding the text of the script file and classifying the encoded text based on a predetermined type.

8. The method according to claim 7 further comprising the step of tagging a corresponding type of category for the classified text and storing it in the dataset.

9. The method according to claim 1 further comprising the steps of:
confirming a voice file related to the video file;
determining whether the file name of the video file includes an episode number; and
confirming narration data for a scene image set as a target based on the determination result.

10. The method according to claim 9 further comprising the step of, if the file name of the video file includes an episode number, setting a scene image corresponding to the episode number among the video files as the target.

11. The method according to claim 9 further comprising the step of performing a voice recognition on the voice file to confirm dialogue data.

12. The method according to claim 11 further comprising matching to calculate an the step of performing string alignment between corpus data of the scene image set as the target and the dialogue data.

13. The method according to claim 12 further comprising the step of, confirming a scene image in which the calculated alignment exceeds a specified value as a result of performing the string matching; and confirming the confirmed scene image as a second image.

14. The method according to claim 13 further comprising the step of calculating a context similarity between the narration data and the dialogue data.

15. The method according to claim 14 further comprising the step of, if the context similarity exceeds the specified value, pairing the narration data and the second image to generate the dataset.

16. The method according to claim 14 further comprising the step of, if the context similarity is less than the specified value, pairing the dialogue data and the second image to generate the dataset.

17. A device for generating natural language-based training data using video and script files and performing image generation and inference using the training data comprising:
a processor; and
a memory for storing an image generation program configured to, when executed by the processor, receive input of a video file and a script file, capture the video file to generate a plurality of scene images, output a first image by applying an image quality filter to the scene image, process the text of the script file into corpus data, and pair the first image and the corpus data to generate a dataset.

18. A method of generating an illustration matching a text-based work by a device for generating natural language-based training data using video and script files and performing image generation and inference using the training data comprising the steps of:
constructing a database by accumulating and storing a dataset in which any image and corpus data have been paired;
receiving a text including any work content as an input;
generating a plurality of scene images matching the text using the database; and
determining scene images selected by a user from among the plurality of scene images as an illustration matching the work.

19. A method of generating an introduction material for a text-based work by a device for generating natural language-based training data using video and script files and performing image generation and inference using the training data comprising the steps of:
constructing a database by accumulating and storing a dataset in which any image and corpus data have been paired;
receiving a text including any work or idea content as an input;
generating a plurality of scene images matching the text using the database; and
generating an introduction material using some scene images selected from among the plurality of scene images.

20. The method according to claim 19 further comprising the steps of classifying the text into a plurality of unit texts; and summarizing the contents included in each unit text, wherein the step of generating the introduction material includes generating the introduction material by mapping the scene images and the summary contents of the unit text corresponding to each scene image.
